(19) United States
(12) Patent Application Publication
(10) Pub. No.: US 2017/0002861 A1
(43) Pub. Date: Jan. 5, 2017

(54) Bearing Assembly for a Drive Shaft Guided in a Protective Tube

(71) Applicant: Andreas Stihl AG & Co. KG, Waiblingen (DE)

(72) Inventors: Robert Davis, Virginia Beach, VA (US); Timo Honold, Virgina Beach, VA (US); Thomas Frandsen, Norfolk, VA (US); Christian Koestler, Virgina Beach, VA (US); Achim Rethaber, Stuttgart (DE); Björn Petersen, Grossbottwar (DE); Andreas Garstenauer, Chesapeake, VA (US); Andreas Giesea, Virginia Beach, VA (US)

(21) Appl. No.: 15/201,413

(22) Filed: Jul. 2, 2016

Related U.S. Application Data
(63) Continuation-in-part of application No. 14/791,277, filed on Jul. 3, 2015.

(51) Int. Cl. F16C 17/26; F16C 33/20; F16C 17/02

(52) U.S. Cl. CPC F16C 17/26; F16C 17/02; F16C 33/208; F16C 2220/04

(57) ABSTRACT

A bearing assembly for a drive shaft guided in a protective tube is provided with bearing tube segments arranged in the protective tube one after another in a longitudinal direction of the protective tube. The bearing tube segments are penetrated by the drive shaft. The bearing tube segments include bearing sections. The bearing sections are provided with a central bearing sleeve and support elements projecting away from an outer circumference of the bearing sleeve. The bearing sleeve is radially supported by the support elements on an inner circumference of the protective tube. The bearing section with its bearing sleeve and support elements is formed as one piece. The bearing tube segments have a length measured in a longitudinal direction of the protective tube and the sum of the lengths of the bearing tube segments is greater than 60% of a length of the protective tube.

### CROSS-REFERENCE TO RELATED APPLICATIONS

This application is a continuation-in-part application of U.S. patent application Ser. No. 14/791,277 having a filing date of 3 Jul. 2015, the entire contents of the aforesaid U.S. patent application being incorporated herein by reference.

### BACKGROUND OF THE INVENTION

The invention concerns a bearing assembly for a drive shaft which is guided in a protective tube and connects a tool with a drive.

The bearing assembly is comprised of several bearing tube segments arranged within the protective tube which, in longitudinal direction of the protective tube, are positioned one after another and are penetrated by the drive shaft. At least one bearing tube segment is configured as a bearing section with a central bearing sleeve, wherein the bearing sleeve comprises support elements projecting away from the outer circumference and by means of which the bearing section is radially supported within the protective tube.

For supporting the drive shaft relative to the protective tube, the bearing sections can be arranged in the area of vibration nodes of the drive shaft. There are also bearing tubes known which are embodied as an extruded plastic tube and inserted into the protective tube and fill the latter across the entire length of the protective tube.

The invention has the object to provide a bearing assembly for a drive shaft guided within a protective tube that can be produced in a simple way, mounted easily, and adapted to various installation conditions.

### SUMMARY OF THE INVENTION

According to the invention, a bearing assembly is provided that supports a drive shaft which is guided within a protective tube and connects a tool with a drive. The bearing assembly is comprised of several bearing tube segments arranged in the protective tube. The bearing tube segments are positioned in longitudinal direction of the protective tube one after another and are penetrated by the drive shaft. At least one bearing tube segment is configured as a bearing section with a central bearing sleeve and comprises support elements that are projecting away from the outer circumference of the bearing sleeve. The bearing sleeve is radially supported by the support elements relative to the inner circumference of the protective tube. In this context, the bearing section that forms a bearing tube segment and is comprised of the bearing sleeve and the support elements is embodied as one piece. Into the protective tube, several sequentially arranged bearing sections are inserted, wherein the sum of the lengths of the inserted bearing tube segments is greater than 60% of the length of the protective tube; the protective tube is filled across more than 60% of its length with bearing tube segments.

The individual bearing sections are shorter than the protective tube; for filling the protective tube, several bearing sections must be inserted one after another. For simple bearing assemblies, it is sufficient to arrange and secure bearing sections at select locations of the protective tube. In order to ensure a good bearing action, the sum of the lengths of the bearing tube segments is greater than 60% of the length of the protective tube.

The configuration according to the invention of a bearing assembly that is assembled of several bearing tube segments provides for a greater design freedom. The individual bearing tube segments can be embodied so as to be adjusted to the occurring local loads so that an efficient use of material is possible. Also, the individual bearing tube segments can be configured in different physical shapes. For forming a bearing assembly, same or different bearing tube segments—for example, matched to the occurring load—can be combined variably with each other. Due to the freedom of combining the bearing tube segments, a load-adjusted bearing action of the drive shaft with minimal use of material is possible.

The arrangement of the bearing sections in the protective tube can be selected such that a first bearing section is supported on a following bearing section. In this context, a first end face of the first bearing section can rest on the following end face of the following bearing section. Possibly occurring axial forces can thus be supported.

In an advantageous further embodiment of the invention, between the bearing sections, an axial spacer element can be provided as a further bearing tube segment so that sequentially arranged bearing sections are supported on each other by means of the axial spacer element.

In order to protect the bearing sections that are contacting each other from spinning, it is provided that an end face of a first bearing section with axially extending engagement elements engages a facing end face of the following bearing section or is contacting with axially extending engagement elements a facing end face of the following bearing section. Expediently, the contact and/or engagement is secured against rotation.

Advantageously, it is provided that the bearing section is arranged in the protective tube in such a way that it is secured with anti-rotation action. In this way, it is ensured that the bearing section is not entrained in rotation by the rotating drive shaft and is not subjected to wear in the protective tube.

The bearing section has a section length that is significantly shorter than the protective tube and is measured from one end of the bearing section to the other end of the bearing section. Preferably, the bearing section has a section length of 10 mm to 300 mm, expediently 100 mm to 200 mm. In an advantageous embodiment, a section length of 150 mm to 160 mm is selected.

The bearing section is preferably embodied as an injection-molded plastic part so that a simple inexpensive manufacture is provided.

An independent inventive concept provides that a bearing section, on the one hand, comprises stiff support elements and, on the other hand, elastically embodied support elements. The elastic support elements and the stiff support elements differ with regard to their stiffness, i.e., their resistance relative to an identical load. The same radial force effects in case of an elastic support element a greater radial deformation than in case of a stiff support element. The bearing section may comprise in particular more than two support elements that differ with regard to their stiffness in radial direction.

In a further embodiment of the invention, the ends of a bearing section support elastic support elements, wherein between the ends of the bearing section at least one stiff support element is arranged. Expediently, at one end of the bearing section exclusively elastic support elements are provided. Advantageously, between the ends of the bearing section at least two stiff support elements are provided and in the intermediate space between the stiff support elements at least one elastic support element is arranged.

Advantageously, the elastic support elements are configured as spring tongues which extend in circumferential direction of the bearing sleeve. The width of a spring tongue is more narrow than the length extension of the bearing sleeve of a bearing section measured in the same direction and in particular amounts to 5% to 10% of the length extension of the bearing sleeve.

The bearing sleeve, the stiff support elements, and the elastic support elements are advantageously formed as one piece. The stiff support element ends at a maximum outer diameter about the bearing sleeve that is smaller or identical to the inner diameter of the protective tube. Relative to the longitudinal center axis of the bearing sleeve, the stiff support element is oriented perpendicular to the longitudinal center axis. Expediently, a stiff support element is positioned in a plane relative to which the longitudinal center axis of the bearing sleeve is extending perpendicularly.

About the circumference of the bearing sleeve, several support elements can be provided that are designed as support arms, for example.

Across the length of the bearing sleeve, several support elements are arranged that are positioned at an axial spacing relative to each other. In particular, different support elements follow in direct or indirect sequence one after another in longitudinal direction. The axial spacing of sequentially arranged support elements can be identical.

A support element is preferably designed as a support ring. In an expedient embodiment, in the outer rim of the support ring, a cutout is formed by means of which an anti-rotation action of the bearing section in the protective tube is achieved. The support ring can have a closed circumference or interrupted circumference.

Expediently, a first bearing section is inserted into the protective tube from the first axial end of the protective tube and the second bearing section from the second axial end of the protective tube. The elastic support elements of the first bearing section that is inserted from the first end of the protective tube are deflected about a first angle opposite to the first insertion direction of the bearing section. The elastic support elements of the second bearing section that is inserted from the second end of the protective tube are deflected by a second angle opposite to the second insertion direction of the bearing section. The first angle forms preferably an alternate angle relative to the second angle.

### BRIEF DESCRIPTION OF THE DRAWINGS

Further features of the invention result from the additional claims, the description, and the drawings in which an embodiment of the invention is illustrated that will be described in more detail in the following.

FIG. 1 shows a schematic illustration of a trimmer carried by a user, comprising a drive shaft which is guided within a protective tube.

FIG. 2 shows in a perspective illustration a bearing section for arrangement in the protective tube of the trimmer.

FIG. 3 shows a side view of the bearing section of FIG. 2.

FIG. 4 shows a longitudinal section view of the bearing section of FIG. 3.

FIG. 5 shows in section view the arrangement of bearing sections in a protective tube.

FIG. 6 shows a section view of bearing sections that engage each other at the ends.

FIG. 7 shows a section view of bearing sections supported on each other by means of a spacer element.

FIG. 8 shows in schematic illustration an arrangement of several bearing sections in a protective tube.

FIG. 9 shows an arrangement of bearing sections in a protective tube wherein the bearing sections are supported on each other by means of spacer elements.

FIG. 10 shows an arrangement of bearing sections with spacer elements which are embodied to be several times longer than a bearing section.

FIG. 11 shows a section view of the bearing sections along the section line XI-XI of FIG. 4.

FIG. 12 shows a plan view of an end of the bearing section in the direction of arrow XII in FIG. 2.

FIG. 13 shows a section view of a protective tube at the location of a bearing section with elliptical support elements.

FIG. 14 shows a section view of a protective tube at the location of a bearing section with circular support elements.

FIG. 15 shows a section view of a protective tube at the location of a bearing section with support elements embodied as radial support arms.

FIG. 16 shows a schematic section view of the full length of a protective tube with an arrangement of bearing tube segments according to FIG. 8.

FIG. 17 shows a schematic section view of the full length of a protective tube with an arrangement of bearing tube segments according to FIG. 9.

FIG. 18 shows a schematic section view of the full length of a protective tube with an arrangement of bearing tube segments according to FIG. 10.

FIG. 19 shows in a schematic illustration the arrangement of bearing tube segments in the form of bearing sections in a curved protective tube.

FIG. 20 shows in perspective illustration a further embodiment of a bearing section.

FIG. 21 shows a side view of the bearing section of FIG. 20.

FIG. 22 shows a section through the bearing section along the section line XXII-XXII of FIG. 21.

FIG. 23 is a plan view of an end face of the bearing section according to FIG. 20.

FIG. 24 is an end view of an end face of a bearing section arranged in a protective tube.

FIG. 25 is a section illustration in accordance with FIG. 22 of a bearing section arranged in a protective tube.

FIG. 26 is an end view of an end face of a bearing section arranged in a protective tube with indication of a section line XXVII-XXVII outside of the longitudinal center axis of the protective tube.

FIG. 27 shows a longitudinal section view along the section line XXVII-XXVII in FIG. 26 outside of the longitudinal center axis of the protective tube with a bearing section.

FIG. 28 is a side view of a bearing section of a further embodiment with identical neighboring support elements.

FIG. 29 is a side view of a bearing section of a further embodiment with a greater number of support elements.

### DESCRIPTION OF PREFERRED EMBODIMENTS

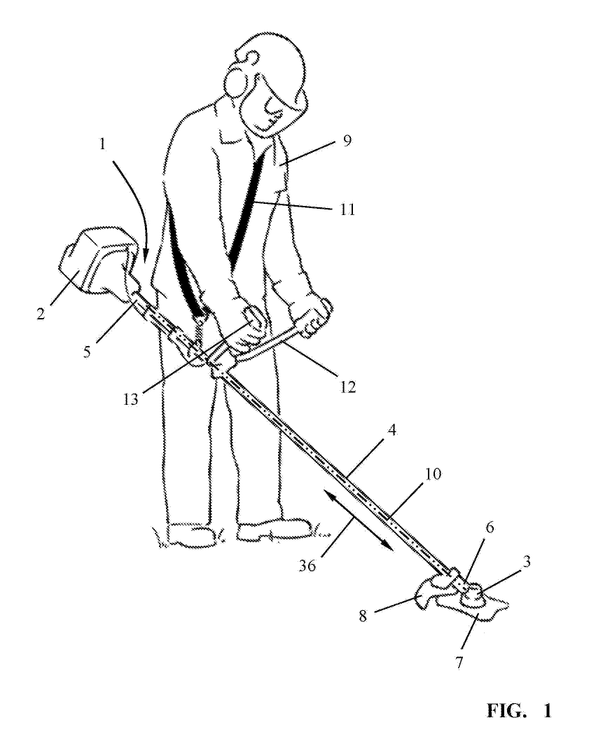

The power tool illustrated in FIG. 1 is a trimmer 1 which is substantially comprised of a drive 2, a tool head 3, and a protective tube 4. The trimmer 1 is one example of a power tool with a protective tube 4; the power tool can also be a pole pruner, a special harvesting device, a hedge trimmer or the like.

The drive 2 is attached to one end 5 of the protective tube 4 while the tool head 3 is mounted on the other end 6 of the protective tube 4. In the illustrated embodiment, the tool head 3 carries a tool 7 of the brush knife kind; multi-blade knives as well as trimmer line cutters or the like can be mounted also as a tool. For protecting the user 9, a deflector 8 is secured at the protective tube 4 in the area of the lower end 6.

In the illustrated embodiment, the trimmer 1 is carried with a belt 11 by the user 9; a grip fastened to the protective tube 4, in the embodiment designed as a handlebar grip 12, serves for holding and guiding the trimmer 1 by the user 9.

On at least one handle 13 of the handlebar grip 12, operating elements for the drive 2 are provided. The drive 2 can be embodied as an electric motor, two-stroke motor, four-stroke motor or similar drive motor.

By means of a drive shaft 10 that is guided within the protective tube 4, the tool 7, in the embodiment a cutter blade, is rotatingly driven by the drive 2.

Within the protective tube 4, the drive shaft 10 is supported so that it can transmit with smooth running the drive power of the drive 2 onto the tool head 3.

Within the protective tube 4, at least one bearing section 14 is arranged wherein in the longitudinal direction 36 of the protective tube 4 several bearing sections 14 are positioned one after another and are penetrated by the drive shaft 10 (shown in an exemplary fashion in FIGS. 5, 8 to 10, 16 to 19). A bearing section 14 which is illustrated in FIGS. 2 to 4 is comprised substantially of a central bearing sleeve 15 having arranged radially projecting support elements 17 on its outer circumference 16. The bearing sleeve 15 and the support elements 17 are preferably embodied as one piece.

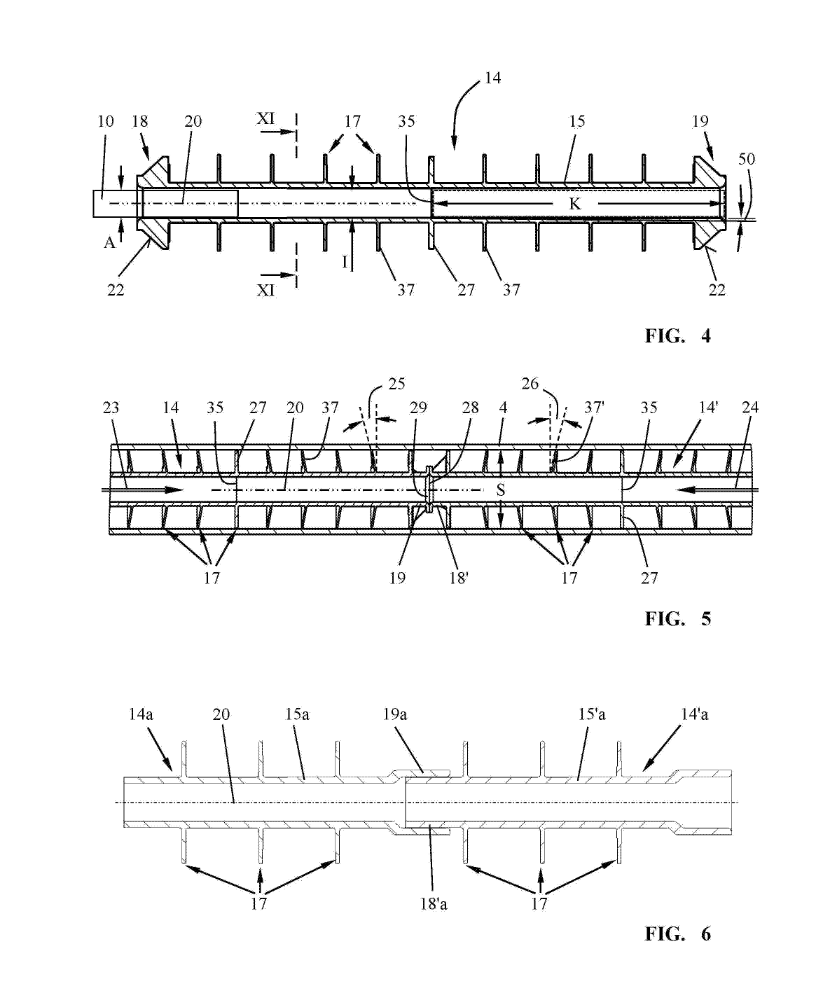

The bearing sleeve 15 has an inner diameter I (FIG. 4) that is matched to the outer diameter A (FIG. 4) of the drive shaft 10.

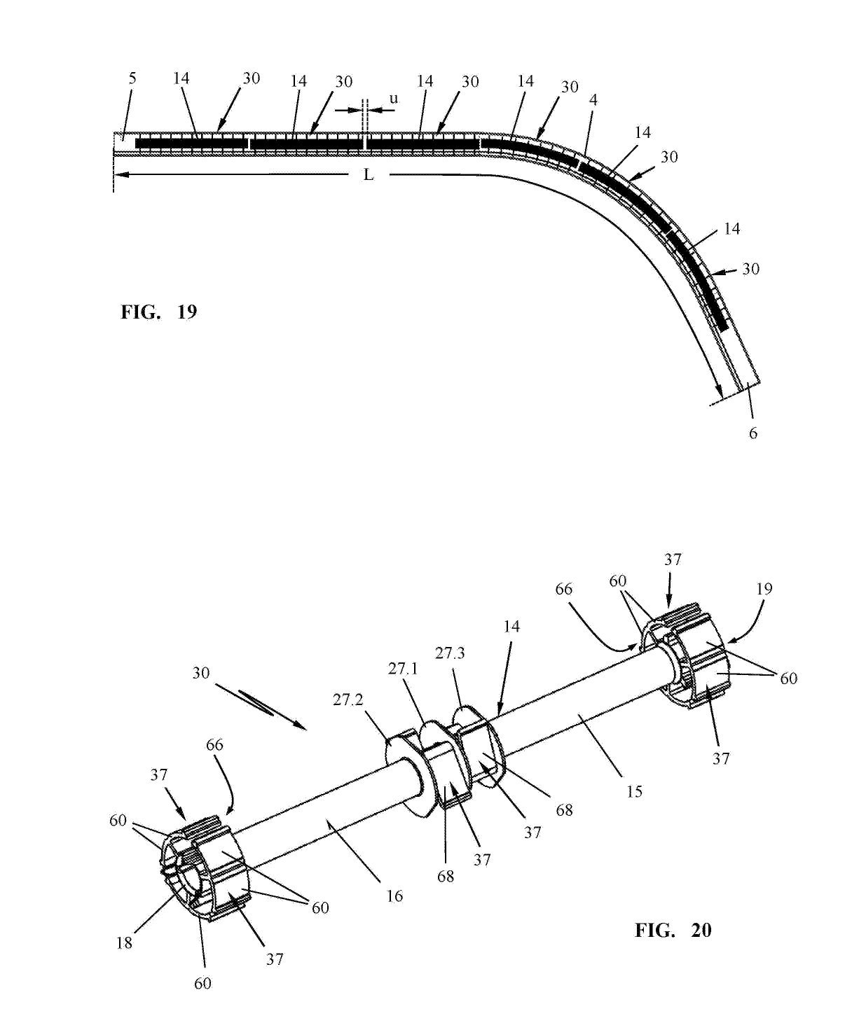

The support elements 17 of the bearing section 14 are comprised of stiff support elements 27 and/or elastic support elements 37. The shape of the stiff support elements 27 and of the elastic support elements 37 can advantageously be identical, as shown in the illustrations of FIGS. 2 to 5. The support elements 17 can also have different shapes and material thickness as shown in an exemplary fashion in the embodiment of FIGS. 20 to 29. Expediently, the support elements 27, 37 have the same shape; advantageously, the support elements 27, 37 are ring-shaped, have a circular shape, a circular segment shape or the like. In a preferred embodiment, the stiff support elements 27 have a thickness D that is preferably thicker than the thickness d of the elastic support elements 37.

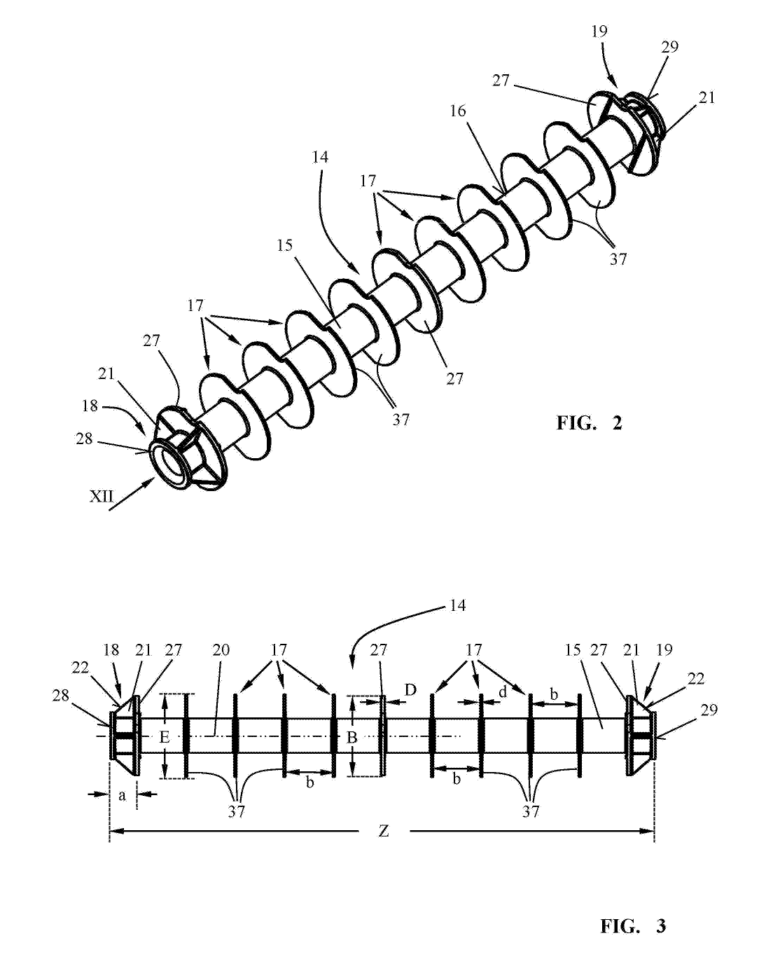

As shown in FIG. 3, for example, the stiff support element 27 has a maximum outer diameter B that is smaller or identical to the inner diameter S (FIG. 5) of the protective tube 4. Preferably, the stiff support element 27 ends on a maximum outer diameter B about the bearing sleeve 15 that is smaller or identical to the inner diameter S (FIG. 5) of the protective tube 4.

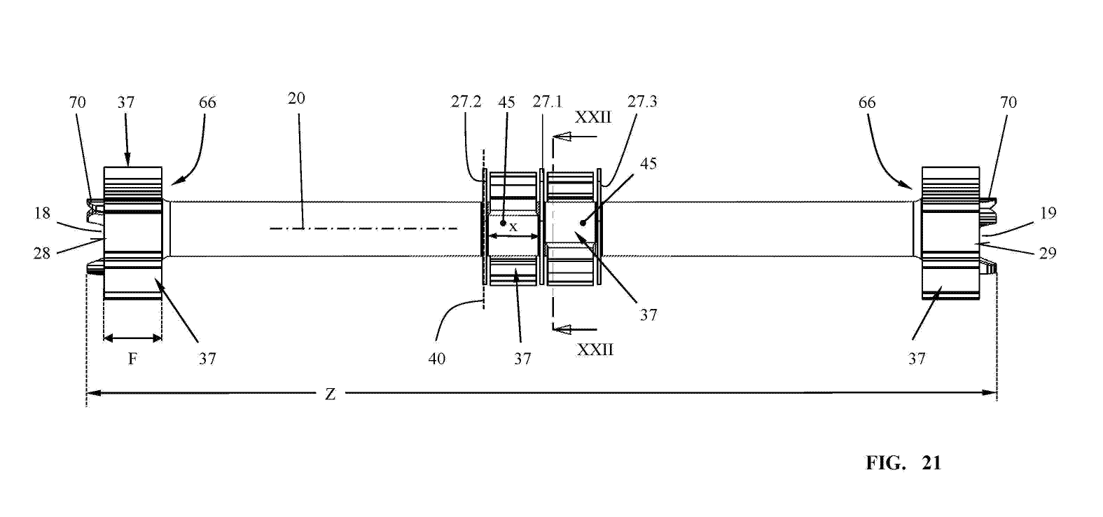

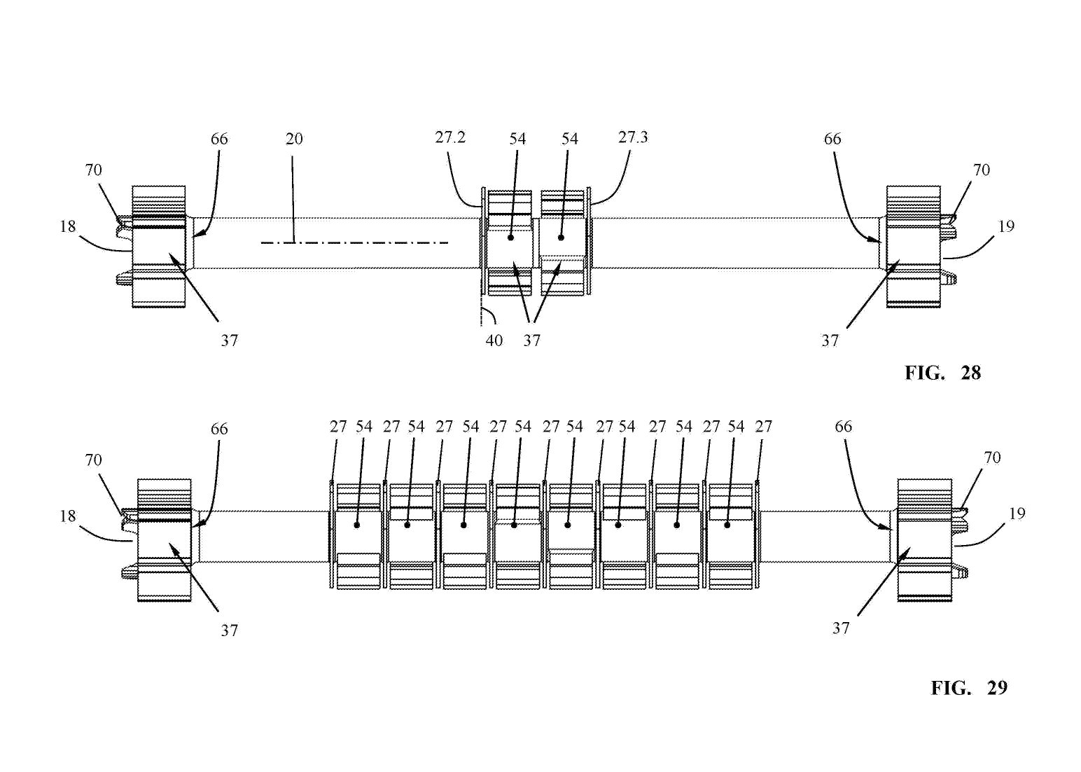

As shown in FIG. 3, the stiff support element 27 is positioned perpendicular to the longitudinal center axis 20 (FIG. 3). The stiff support element 27 is in particular designed as an annular disk-shaped rib that extends in the circumferential direction of the bearing sleeve 15. The rib is positioned in a plane 40 (FIGS. 21, 28) and the longitudinal bearing axis 20 of the bearing sleeve 15 is positioned perpendicularly relative to the plane 40. The stiff support element 27 defines a plane 40 and the longitudinal bearing axis 20 of the bearing sleeve 15 is positioned at a right angle thereto. As shown in FIGS. 2 to 4, the bearing sleeve 15 comprises a first end 18 and a second end 19. A first stiff support element 27 is positioned between the ends 18, 19 of the bearing sleeve 15. In the illustrated embodiment, the stiff support element 27 is positioned at half the section length Z of the bearing section 14. Other arrangements on the bearing section 14 or the bearing sleeve 15 can be expedient.

In the illustrated embodiment according to FIGS. 2 to 10, in the area of the ends 18, 19 a further stiff support element 27 is provided, respectively. In this context, the stiff support element 27 is positioned at a spacing a relative to the end face 28, 29 of the bearing sleeve 15 or the bearing section 14. Between the end 18, 19 of the bearing sleeve 15 and the stiff support element 27 at the end 18, 19 of the bearing sleeve 15, a threading element 21 is formed whose outer contour 22 rises from the end 18, 19 of the bearing sleeve 15 toward the stiff support element 27. As can be seen in FIGS. 2 to 4, the threading element 21 is designed in a side view as a triangular rib.

Advantageously, elastic support elements 37 are provided between the stiff support elements 27. It may be expedient to provide a bearing section exclusively with elastic support elements of same or different shape. As shown in FIG. 3, the elastic support elements 37 end on a maximum outer diameter E about the bearing sleeve 15. The outer diameter E is minimally greater than the inner diameter S (FIG. 5) of the protective tube 4. Minimally greater is to be understood as an outer diameter E of the elastic support element 37 that is greater by 0.5% to 5% than the inner diameter S of the protective tube 4.

As shown in FIG. 3, between the stiff support elements 27 arranged at the ends 18 and 19 and the central support element 27, four elastic support elements 37 are positioned, respectively. In particular, the support elements 27, 37 in longitudinal direction 36 of the longitudinal center axis 20 are positioned at the same axial spacing b relative to each other. Variable axial spacings b can be advantageous, e.g., the spacings b can be selected so as to be adjusted to the occurring load.

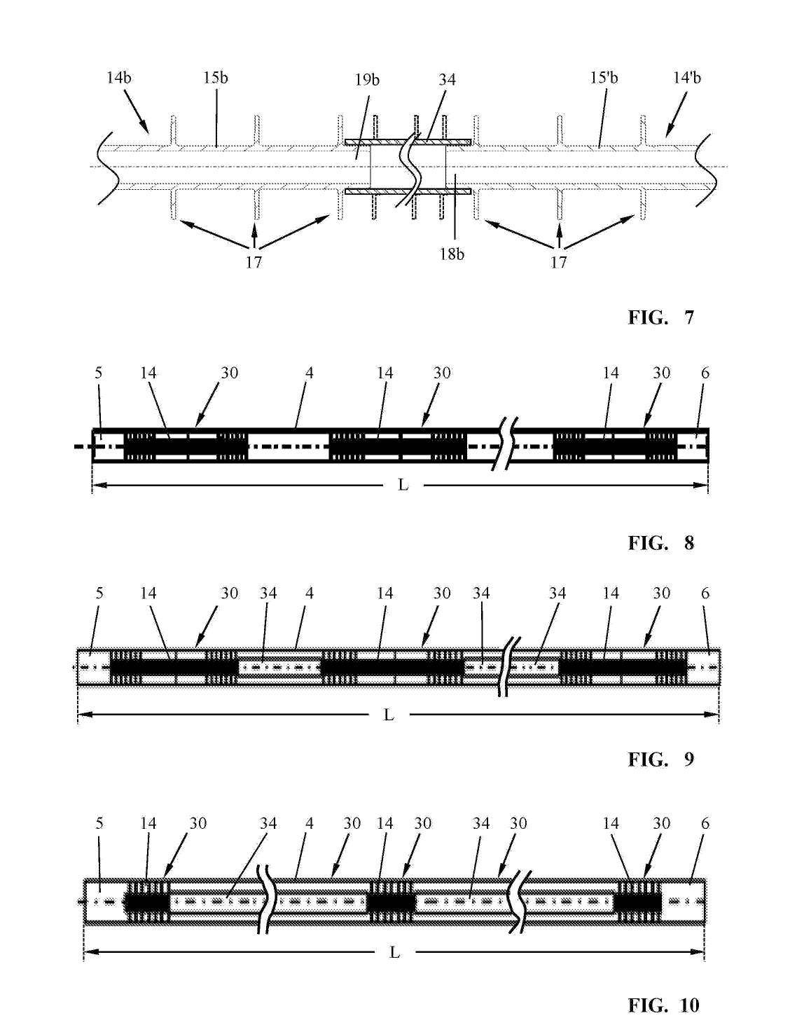

The bearing sections 14 inserted into a protective tube 4 for supporting the drive shaft 10 and optionally arranged spacer elements 34 are generally also referred to as bearing tube segments 30. According to the invention, bearing tube segments 30 are inserted into the protective tube 4 from the first end or the second end of the protective tube 4. Such a bearing tube segment 30—as shown in FIGS. 2 to 4—may be embodied as bearing section 14 or—compare FIGS. 7, 9, and 10—provided as a spacer element 34. In the protective tube 4 several sequentially arranged bearing tube segments 30 are accommodated, wherein, according to the invention, a certain degree of filling of the protective tube 4 is provided. The bearing tube segments 30, at least several bearing sections 14, fill the protective tube across more than 60% of its length. When also spacer elements 34 are provided as bearing tube segments 30, the bearing sections 14 and the spacer elements 34 fill the protective tube 4 across more than 60% of its length L. In other words, the sum of the lengths SL of the bearing tube segments 30 arranged in a protective tube 4 is greater than 60% of the length L of the protective tube 4 (FIGS. 16 to 18).

In a first embodiment, as shown in FIG. 5, the filling of the protective tube 4 can be realized across more than 60% exclusively with bearing sections 14.

In this context, the end faces 28, 29 of sequentially arranged bearing sections 14 can contact each other at their ends 18 and 19. In this context, it is advantageous to insert one bearing section 14 from the first axial end of the protective tube 4 in the direction of arrow 23 into the protective tube 4 and the other bearing section 14′ from the second axial end of the protective tube in the direction of arrow 24 into the protective tube 4. Due to the oversize of the elastic support elements 37, the support elements 37 of the bearing section 14 are deflected by an angle 25 opposite to the insertion direction 23; in the same way, the elastic support elements 37′ of the bearing section 14′ are deflected opposite to the insertion direction 24 by an angle 26. Accordingly, the elastic support elements 37 of the bearing section 14 that has been inserted from the end 5 of the protective tube in the insertion direction 23 are positioned at a first angle 25 relative to the first insertion direction 23 of the bearing section 14; the elastic support elements 37′ of the bearing section 14′ that has been inserted from the other end 6 of the protective tube 4 in the insertion direction 24 are positioned at a second angle 26 relative to the second insertion direction 24 of the bearing section.

In a further embodiment of the bearing tube segments 30, their ends are designed differently, e.g., for forming a continuous bearing assembly by partial insertion into each other. With the example of the bearing sections 14a according to FIG. 6, one end 19a has been expanded to a receiving socket in such a way that the facing end 18′a of a following bearing section 14′a is received in the receiving socket. The bearing sleeves 15a, 15′a of the bearing sections 14a, 14′a engage each other at their ends and form an assembled bearing tube. The spacer elements 34 can be designed accordingly. In this way, the bearing tube segments 30, i.e., bearing sections 14 and/or spacer elements 34 can be pre-mounted to a continuous unit (bearing assembly) prior to insertion into the protective tube 4. The configuration of a bearing tube segment 30 can be designed such that its ends are embodied identical (compare e.g. the ends 18, 19 of the bearing sections 14 in the FIGS. 2 to 4). Accordingly, several bearing tube segments 30 can be expediently strung together in a row in that a following bearing tube section 14 and/or a spacer element 34 at its ends is provided e.g. with a greater diameter. Sequentially arranged bearing tube segments 30 can be connected to each other by insertion into each other. The assembly or preassembly of the bearing tube segments 30 is facilitated because the individual bearing tube segment 34 has no predetermined orientation for installation.

In the embodiment according to FIG. 7 with the example of bearing sections 14b, 14′b, the ends 18b and 19b of the bearing tube segments 30 are of identical configuration; the bearing sleeves 15b, 15′b of the bearing sections 14b, 14′b end with the same diameter; the ends are of identical design. For supporting the bearing sections 14b, 14′b relative to each other, bearing tube segments 30 are provided e.g. as spacer elements 34 which are designed like a connecting socket. The ends 18b, 19b of sequentially arranged bearing sections 14b, 14′b are inserted into the spacer element 34; the first support elements 17 which are arranged on the bearing sections 14b, 14′b delimit the insertion depth of the ends 18b and 19b into the spacer element 34. The spacer element 34 which is illustrated in FIG. 7 is designed without support elements; it may be expedient to design the spacer element 34 also as a bearing section in that on the outer circumference of the spacer element 34 support elements 27 and/or 37 are arranged, as indicated in FIG. 7 by dashed lines.

In the embodiment according to FIG. 8, bearing sections 14 are exclusively provided as bearing tube segments 30 in the protective tube 4; the degree of filling across the length of the protective tube 4 with bearing sections 14 amounts to more than 60% of the length L of the protective tube 4. As illustrated in FIG. 16, spacings u1, u2, u3, u4, and u5 of different length are provided between the bearing sections 14. The bearing tube segments 30 are formed exclusively by bearing sections 14 wherein several bearing sections 14 may contact each other directly (FIG. 5) and form a first group of several bearing sections which is positioned at a spacing relative to a second group of several bearing sections. The bearing sections 14 can have the same section length Z. In the embodiment according to FIG. 16, the bearing sections 14 are designed with different section lengths Z1, Z2, Z3, Z4, Z5, and Z6. The section lengths Z1 to Z6 as well as the spacings u1 to u5 of the bearing sections 14 relative to each other can be selected in accordance with the mechanical stationary and/or dynamic loads. Accordingly, a great variability results so that a load-adapted bearing assembly can be configured for the drive shaft 10 in the protective tube 4.

The protective tube 4 has a length L; the sum of section lengths Z1, Z2, Z3, Z4, Z5, and Z6 is greater than 60% of the length L of the protective tube 4.

In FIG. 9, bearing tube segments 30 are sequentially arranged in the longitudinal direction 36 of the protective tube 4 wherein the bearing tube segments 30 are comprised of bearing sections 14 and spacer elements 34. As shown in FIG. 9, a bearing section 14 is provided at each end of a spacer element 34. Several bearing sections 14 can be immediately sequentially arranged, as illustrated e.g. in FIG. 5. As can be seen from the illustrated total length L of the protective tube 4 in FIG. 17, bearing sections 14 and spacer elements 34 can advantageously alternate.

The illustration of the protective tube 4 as a whole shows that not only the bearing sections 14 can have different section length (compare FIG. 16); also the spacer elements 34 can have different axial lengths. The sum of the lengths SL of the spacer elements 34 and of the bearing sections 14 is greater than 60% of the length L of the protective tube 4. In other words, the degree of filling of the protective tube 4 with bearing tube segments 30 is greater than 60% across the length L.

In the embodiment according to FIG. 9, the bearing sections 14 are approximately of the same length or longer than the spacer elements 34; this is one of the various possible configurations. In the embodiment according to FIG. 10, a configuration is provided in which the spacer elements 34 are longer, in particular several times longer, than the bearing sections 14. In FIG. 18, the filling of the protective tube 4 is illustrated which is selected across its length such that more than 60% of the length L of the protective tube 4 is filled with bearing sections 14 and spacer elements 34. In the illustrated embodiment, across the length L of the protective tube 4, three bearing sections 14 are arranged between which a spacer element 34 is arranged, respectively. The spacer elements 34 support the bearing sections 14 relative to each other; the sum of the lengths SL of the bearing sections 14 together with the length of the spacer elements 34 is greater than 60% of the length L of the protective tube 4. In the embodiment according to FIG. 18, the sum of the lengths SL is approximately 90% to 95% of the length L of the protective tube 4.

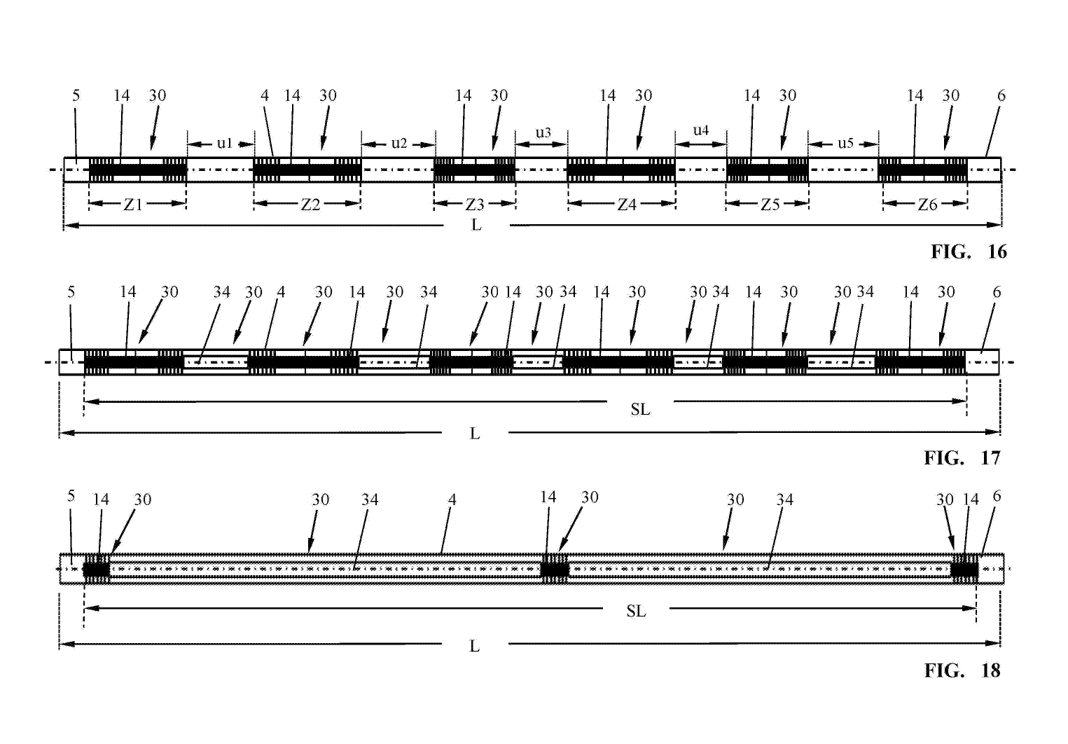

The bearing sections 14, 14a, 14b are secured with anti-rotation action in the protective tube 4. Advantageously, in accordance with FIGS. 11, 12, and 14, it is provided that the support elements 17, i.e., the stiff support elements 27 and/or the elastic support elements 37, are designed as circular rings wherein in the outer rim 31 of a circular ring at least one cutout or notch 32 is formed. The cutouts or notches 32, as shown in FIG. 11, can be positioned diametrically opposite each other. A notch 32 interacts with an inner longitudinal bead 57 of the protective tube 4 which is present as a result of the manufacturing process of the protective tube 4. The protective tube 4 can be manufactured e.g. as a welded tube, a drawn tube or the like.

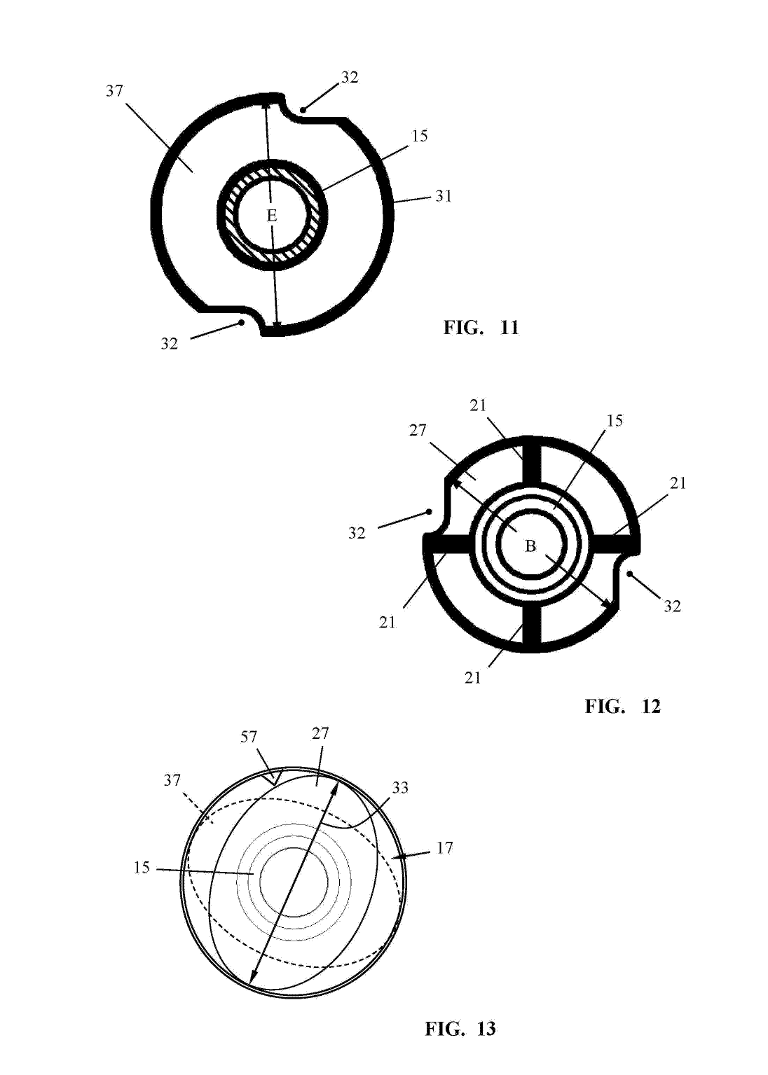

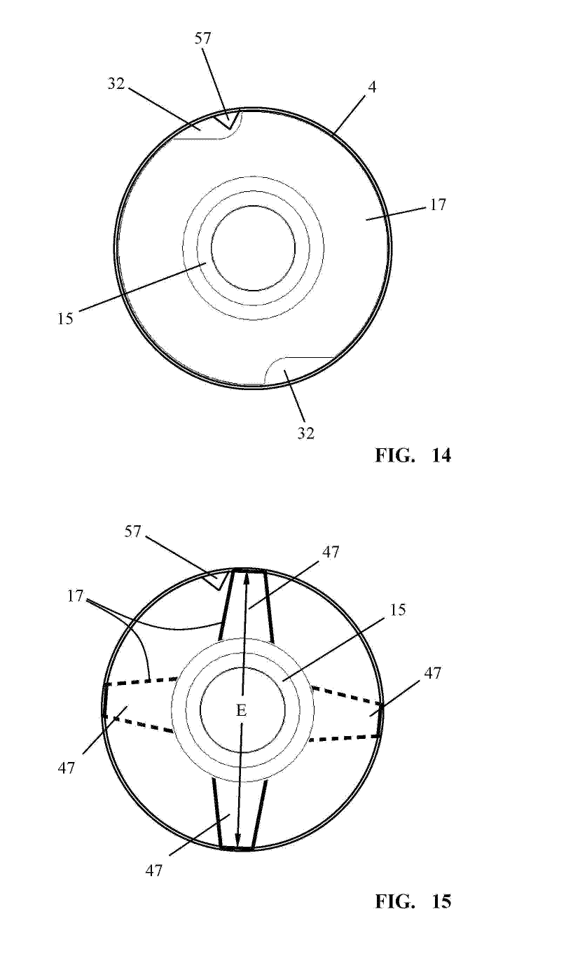

It can be sufficient to provide exclusively the stiff support elements 27 with notches 32, as illustrated in FIG. 12. Advantageously, the circular ring-shaped stiff support elements 27 and the circular ring-shaped elastic support elements 37 are provided with notches 32.

Alternative configurations of the support elements 17 can be advantageous. For example, FIG. 13 shows elliptically designed support elements 17 that can be provided as stiff support elements 27 and/or as elastic support elements 37. The elliptical support elements 17 have a major axis 33 which, as an elastic support element, is designed in accordance with the outer diameter E in FIG. 3 or, as a stiff support element, in accordance with the outer diameter B. It can be advantageous to arrange the elliptical support elements 17 so as to be rotated relative to each other, as indicated in FIG. 13 in dashed lines. The elliptical support element 17 is secured against rotation by the longitudinal bead 57 on the inner circumference of the protective tube 4.

In an alternative embodiment according to FIG. 15, the support elements 17 are designed as support arms. Two support arms 47 each are positioned diametrically opposite each other, wherein four support arms 47 can be arranged about the circumference of the bearing sleeve 15. The support arms 47 end on a maximum outer diameter E that is greater by 0.5% to 5% than the inner diameter S of the protective tube 4 (FIG. 5). The support arms 47 can be designed as stiff and/or elastic support elements 27, 37. It may be expedient to arrange the support arms 47 that are neighboring each other in longitudinal direction of the bearing sleeve 15 so as to be displaced relative to each other in circumferential direction, as indicated in FIG. 15 in dashed lines.

The bearing section 14 comprised of the bearing sleeve 15 and of the support elements 17 is manufactured as one piece as an injection-molded plastic part. The bearing section 14 has a section length Z in the range of 10 mm to 300 mm, preferably 100 mm to 200 mm, in particular 150 mm. The section length Z for injection molding of the bearing section 14 is limited by the length K of the core inserts during injection molding. When two core inserts are used, which preferably are meeting approximately at the center of the bearing sleeve 15, upon injection molding a butt joint results—as shown in FIG. 4—which is illustrated as a circumferentially extending inner seam 35 and which does not impair the bearing properties of the bearing sleeve 15.

In FIGS. 1 and 8 to 10, straight protective tubes of the length L are shown. The length of a protective tube 4 can be in the range of 800 mm to 1,500 mm, wherein the cross-section of the protective tube 4 is preferably round. Cross-sectional shapes for a protective tube 4 that deviate from a round cross-section can be advantageous.

The protective tube 4 can also be of a curved configuration, as shown in FIG. 19. The bearing sections 14 and/or the spacer elements 34 can be elastically bent across their section length Z or a part of their section length Z so that e.g. a bearing section 14 is bent in accordance with the curvature of the protective tube 4. In case of large radii of curvature of the protective tube 4 also short stiff bearing sections 14 can be employed which align themselves in the protective tube 4 and relative to the drive shaft 10 by means of their elastic support elements 37. In the embodiment according to FIG. 16, the protective tube 4 is filled across more than 60% of its length L with bearing sections 14. The sum of the section lengths Z of the bearing sections 14 is greater than 60% of the length L of the protective tube 4. The bearing sections 14 can be resting with their end faces against each other. In FIG. 16, a minimal spacing u between neighboring bearing sections 14 is provided.

As shown in FIG. 4, the inner diameter I of the bearing sleeve 15 can widen in the direction toward the ends 18, 19. The inner diameter I of the bearing sleeve 15 is thus greater at the respective end 18, 19 of the bearing sleeve 15 than in the area of the center of the bearing sleeve 15, in particular at the location of the inner seam 35. When manufacture is performed by injection molding, advantageously drafts are provided so that the inner diameter I of the bearing sleeve 15 changes across its length. For a targeted stiffness adjustment of the bearing sleeve 15, at the ends of the bearing sleeve 15 advantageously support elements 37 are arranged that are different from the support elements 27 provided in the central area of the bearing sleeve 15, wherein the inner diameter is reduced to the height of the support elements 27.

Beginning at the inner seam 35 or the center of the bearing section 14, the inner diameter I widens by an angle 50 of approximately 0.01° to 1°, preferably 0.02° to 0.1°. In this way, at the ends 18, 19 of the bearing sleeve 15 a wider diameter results.

In case of an injection molding process with identical material, it is provided according to the embodiment that elastic support elements 37 are provided by forming them with a thinner material thickness than the stiff support elements 27. When the bearing section 14 is cast by a multicomponent method, other materials can be employed for the elastic support elements than for the remaining sections of the bearing section. In this way, the same material thickness for all support elements can be provided, for example; the required elasticity is then provided as a result of different material properties.

FIGS. 20 to 29 show further embodiments of bearing tube segments 30 embodied as bearing sections 14. The explanations provided above in connection with FIGS. 1 to 19 in connection with the configuration and design of the support elements 17 (stiff support elements 27, elastic support elements 37) apply likewise to the embodiments of FIGS. 20 to 29. In the same way, the following explanations are also applicable to the embodiments of FIGS. 1 to 19. The features and disclosures regarding the various embodiments can be combined with each other and can be transferred from one embodiment onto another embodiment.

In FIGS. 20 to 29 further embodiments of a bearing section 14 for forming a bearing tube are illustrated. Same parts are identified with same reference characters.

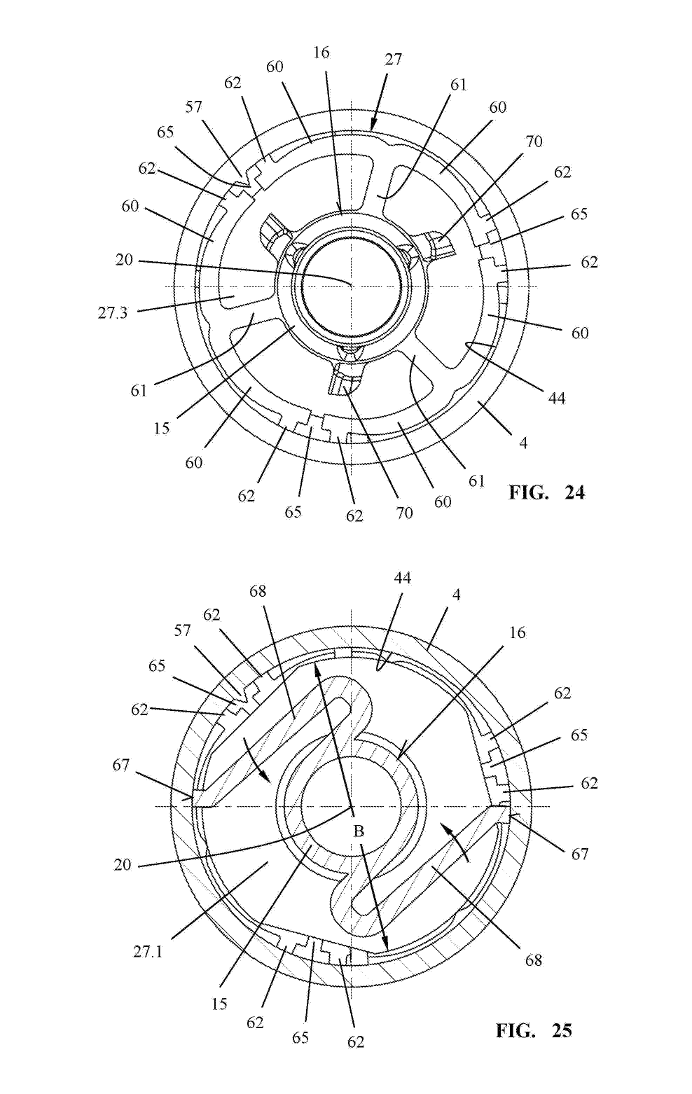

The bearing tube in the illustration according to FIGS. 20 and 21 is comprised substantially of the bearing sleeve 15 and support elements 17 which are arranged on the outer circumference of the bearing sleeve 15. At the ends 18, 19 of the bearing sleeve 15, elastic support elements 37 are provided which are designed as spring tongues 60. A spring tongue 60 extends, as shown in FIG. 23, in circumferential direction of the bearing sleeve 15 wherein advantageously two spring tongues 60 are held by a support rib 61. The two spring tongues 60 and the support rib 61 form a “T” in the view of FIG. 23. Three support ribs 61 with two spring tongues 60 each are provided about the circumference of the bearing sleeve 15.

A different number of support ribs 61 and/or spring tongues 60 per support rib 61 may also be provided. The support ribs 61 can be distributed uniformly but also non-uniformly about the circumference of the bearing sleeve 15 so that between neighboring support ribs 61 identical or different circumferential angles can be provided. In case of a non-round shape of the protective tube 4, differing circumferential angles may be advantageous.

Each spring tongue 60 supports at its free end a contact section 62 with which the spring tongue 60, as shown in FIG. 24, is contacting the inner circumference 44 of the protective tube 4. The contact sections 62 end on a diameter circle E, also shown in the preceding embodiments (for example, FIG. 3).

In the undeformed state according to FIG. 23, the contact sections 62 project past a diameter circle 64 which corresponds to the inner diameter S of the protective tube 4.

The width F of a spring tongue 60 is in particular 3 mm to 60 mm; in particular, the width F is approximately 3% to 10% of the length L of the bearing section 14 (FIG. 21).

The spring tongues 60 form an elastic terminal head 66 of the bearing section 14.

At least one stiff support element 27 is provided between the ends 18 and 19 with the elastic terminal heads 66. The stiff support element 27 is positioned in a plane 40; the longitudinal center axis of the bearing sleeve 15 is perpendicular relative to the plane 40. Transverse to the plane 40, the stiff support element 27 has advantageously a width that is smaller compared to the extension along the plane 40. The maximum outer diameter B (FIG. 25) of the stiff support element 27 is advantageously at least 10 times as great as its width. The stiff support element 27 comprises advantageously a flat planar configuration in the form of an annular disk. The outer diameter B (FIG. 25) is to be understood as an envelope; the support element 27 itself can also have a cross-sectional shape that deviates from a circular shape.

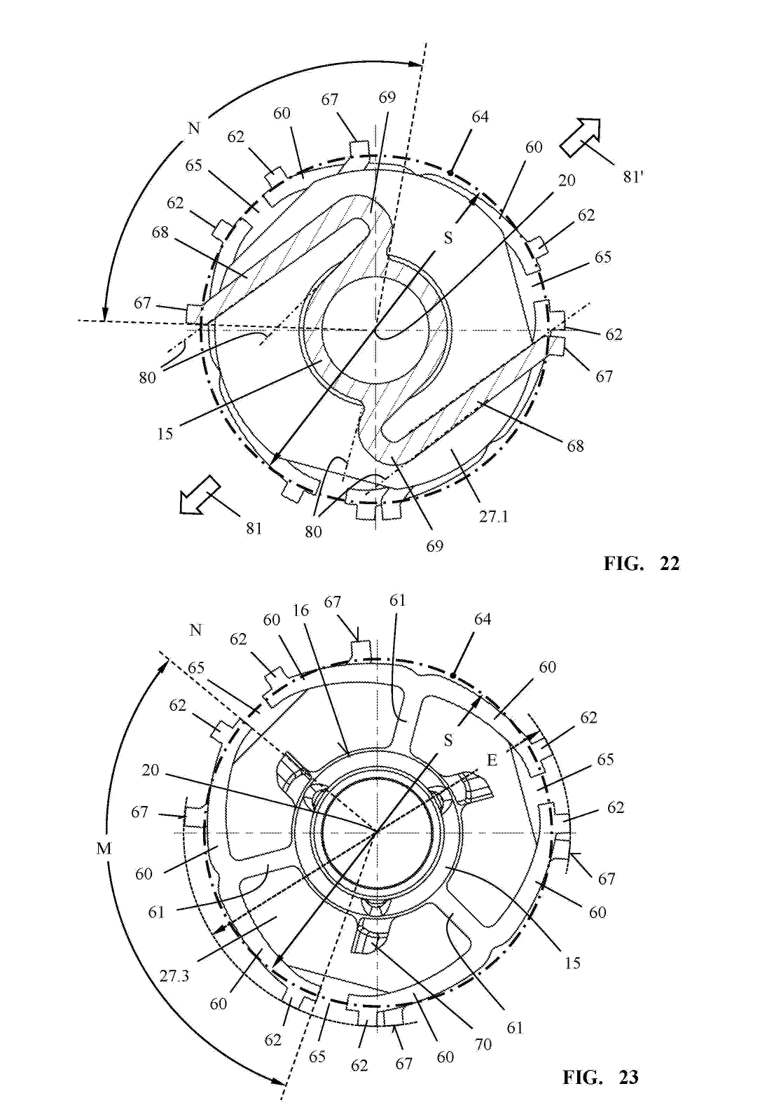

In the illustrated embodiment according to FIGS. 20 and 21, a first stiff support element 27.1 is arranged centrally relative to the ends 18 and 19. On both sides of the central stiff support element 27.1, a further stiff support element 27.3, 27.2 is arranged, respectively. The support elements 27.1 and 27.2 or 27.1 and 27.3 delimit an intermediate space 45, respectively, with a width x that is measured in a direction of the longitudinal center axis 20. In each one of the intermediate spaces 45, an elastic support element 37 is arranged which is illustrated in FIGS. 22 and 25 in a section view.

The elastic support element 37 in the intermediate space 45 is designed as a preferably straight spring tongue 68 which is extending approximately tangentially to the outer circumference 16 of the bearing sleeve 15. In the illustrated embodiment according to FIGS. 22 and 25, two spring tongues 68 are positioned relative to the longitudinal center axis 20 of the bearing sleeve 15 approximately diametrically opposed to each other. Each spring tongue 68 is connected by means of a connecting section 69 that is U-shaped to the bearing sleeve 15. The free end of the spring tongue 68 is designed as a radial contact surface 67, serving for contacting the inner circumference 44 of the protective tube 4, as shown in FIG. 25. The elastic support element 37 ends with the contact surface 67 at the diameter E.

Across the axial length of a bearing section 14, elastic support elements 37 are therefore provided at the ends 18 and 19. In the embodiment, three stiff support elements 27.1, 27.2, and 27.3 are provided between the ends 18 and 19 and are positioned in a plane 40; the longitudinal center axis 20 of the bearing sleeve 15 is extending perpendicularly to the plane 40. The stiff support elements 27.2 and 27.3 are positioned at a spacing x to the central support element 27.1 wherein in the intermediate spaces 45 further elastic support elements 37 are arranged. The elastic support elements 37 in the intermediate spaces 45 as well as at the ends 18, 19 of the bearing section 14 project in the unloaded state past the diameter circle 64 of the inner diameter S. When mounting the spring tongues 68, 60 in the protective tube 4 according to FIG. 25, the spring tongues 68, 60 are forced radially inwardly away from their outer diameter E of the unloaded state and are contacting then with their contact surfaces 67, 62 under spring force the inner circumference 44 of the protective tube 4. In the embodiment, the outer diameter E in the unloaded state is identical for all spring tongues 68, 60. It can be advantageous that the elastic support elements 37 differ in regard to their outer diameter E. Advantageously, the spring tongues 68 in the central area of the bearing section 14 point in different rotational directions. In this way, a prestressed support action in both directions can be realized also in the central area of the bearing section 14 in analogy to the T-shaped elastic support element 37 provided in the end area.

The axial width x of the elastic support elements 37 or of the spring tongues 68 in the central area of the bearing section 14 corresponds approximately to the axial width F of the spring tongues 60 at the ends 18, 19 of the bearing section 14. The widths F and x of the elastic support elements 37 can be matched in a targeted fashion to the local loads. In particular, the widths F and x have different magnitudes. The sum of all axial widths of all support elements 17 (elastic support elements 37, stiff support elements 27) amounts advantageously to less than 90% of the section length Z of the bearing section 14. Expediently, the sum of all axial widths of the stiff support elements 27 and of the elastic support elements 37 amounts to less than 70%, in particular less than 50% of the section length Z of the bearing section 14. This configuration ensures that at least 10% of the section length Z of the support section 14 is without immediate radial support in the protective tube 4. In order to provide for a good support action, advantageously at least 10% of the length of the bearing section 14 is radially supported.

An individual elastic support element 37 at one end 18 and/or 19 of the bearing section 14 extends as a whole across at least 180° of the circumference of the bearing sleeve 15. The total length extension results from the sum of the individual length extensions M of the individual spring tongues 60. The bearing sleeve 15 is covered across at least half of its circumference in radial direction by the elastic support element 37. Expediently, an extension or overlap of more than 270°, in particular more than 300°, circumferential angle is expedient.

An individual elastic support element 37 between the stiff support elements 27 extends advantageously in total across a circumferential angle of less than 200°, in particular approximately 180°, wherein each spring tongue 68 exhibits an individual overlap (coverage) N of advantageously half of the total overlap, i.e., approximately 90°, with the bearing sleeve 15, as can be seen in particular in FIGS. 22 and 25. Due to the reduced angle of overlap (coverage) N relative to the support elements 37 in the end area 18, 19, removal of the spring tongues 68 transverse to the longitudinal direction of the bearing sleeve 15 in removal direction 81 or 81′ is possible. For this purpose, corresponding drafts 80 for removal from the mold are formed. In case of a smaller overlap angle, processing of the bearing sections 14 when mounting as bulk material or loose material is made difficult. The stiff support elements 27 are designed such that hooking or catching of two spring elements 60, 68 belonging to different bearing sections 14 is prevented.

The elastic support elements 37 of the terminal heads 66 are designed such that a gap 65 is remaining between facing ends of the spring tongues 60. As shown in FIG. 24, the gap 65 is suitable for receiving the longitudinal bead 57 of the protective tube 4. The radial contact surfaces 67 of the contact sections 62 are therefore positioned advantageously on both sides of the longitudinal bead 57 so that a rotational securing action (anti-rotation action) of the bearing section 14 is ensured at the same time. The spring tongues 60 of the elastic support elements 37 in the end area are advantageously removed from the mold along the longitudinal direction of the bearing section 14. The gaps 65 between the facing spring tongues 60 are advantageously selected such that hooking or catching of a spring tongue 60 of another bearing section 14 is prevented. The angular spacings between neighboring spring tongues 68 of an elastic support element 37 in the central area of the bearing section 14 in circumferential direction are greater than in case of spring tongues 60 of the elastic support elements 37 in the area of the ends 18, 19 of the bearing section 14.

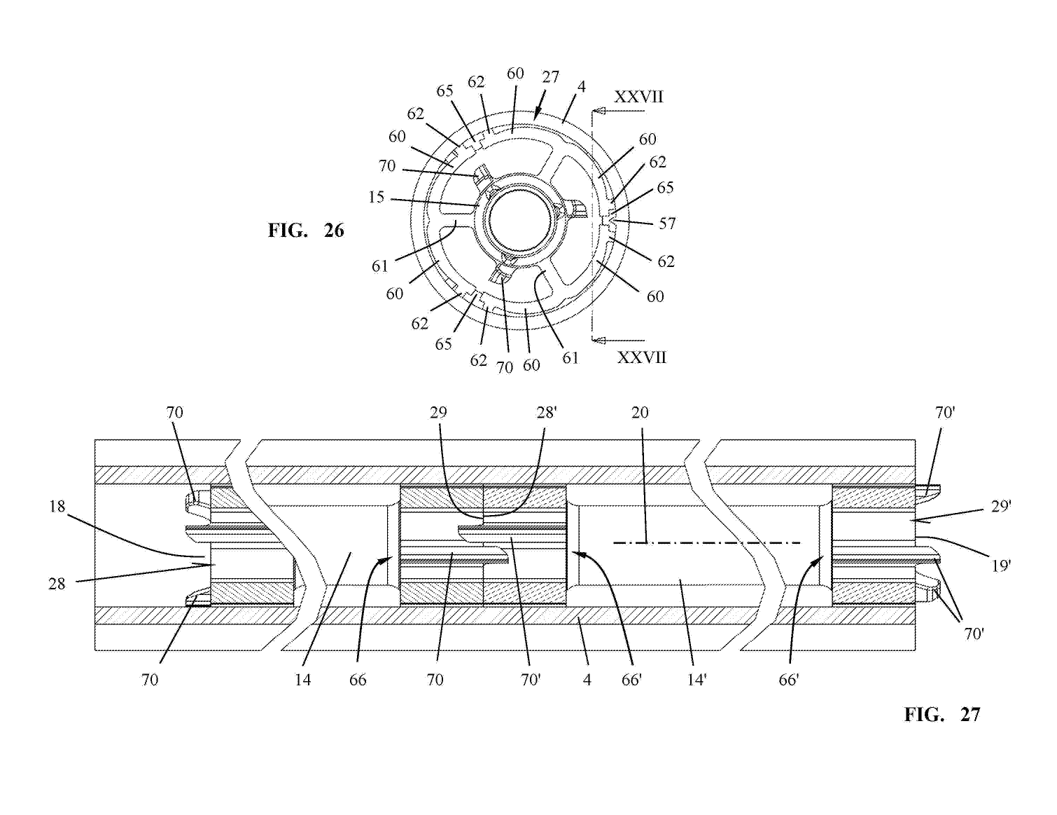

FIG. 26 shows a bearing section 14 arranged in a protective tube wherein the illustration according to FIG. 27 shows a section along the section line XXVII-XXVII. In FIG. 27, a first bearing section 14 and a following bearing section 14′ are provided which are contacting each other with their ends 18, 19. In this context, as shown in FIG. 27, the end faces 28 and 29 can be contacting each other axially.

According to a further embodiment of the invention, engagement elements 70 are provided which are projecting axially from the end face 28 or 29. The length Z of the bearing sections 14 illustrated in the embodiments of FIGS. 20 to 29 is enlarged accordingly by the length of the engagement elements 70. As shown in FIG. 27, the engagement elements 70 are advantageously arranged on the outer circumference 16 of the bearing sleeve so that the engagement elements 70 of the bearing sleeve 14 and the engagement elements 70′ of the following bearing sleeve 14′ slide into a position adjacent to each other and thus can contact each other in circumferential direction. In this way, a bearing section cannot spin relative to a following bearing section. In particular, the bearing sections 14 and 14′ are connected to each other with anti-rotation securing action by the axially engaging engagement elements 70, 70′ in circumferential direction. The engagement elements 70, 70′ are positioned preferably between the support ribs 61 of the spring tongues 60 of the terminal heads 66.

The engagement elements 70 have advantageously relative to each other the same angular spacing that the gaps 65 have relative to each other. In an assumed operating situation in which a bearing section 14 with its gap 65 slips across the longitudinal bead 57, this bearing section 14 can rotate only up to the point where the next gap 65 engages the longitudinal bead 57. Advantageously, the engagement elements 70, 70′ prevent a relative rotation of the bearing sections 14 relative to each other in only one rotational direction.

In longitudinal direction of the bearing section 14, several and different support elements 27, 37 with a limited axial length are arranged, respectively. Advantageously, different support elements 27, 37 are positioned adjacent to each other wherein also identical support elements 27, 37 can directly follow each other with axial spacing (FIG. 28).

In FIG. 28, a bearing section 14 of a further embodiment is shown. In comparison to the bearing section of FIG. 21, the central stiff support element is omitted. The elastic support elements 37 with the spring tongues 68 are positioned adjacent to each other without separating stiff support elements 27. The width of the spring tongues 60, 68 and the axial spacing of the identical support elements 27, 37 are advantageously selected such that hooking or catching of a foreign spring tongue is avoided.

The contact location 67, 62 of the spring tongue 68, 60 is advantageously angularly displaced relative to a contact location 67, 62 of an axially following spring tongue 68, 60 of the same bearing section 14.

In the embodiment according to FIG. 29, between the elastic terminal heads a plurality of intermediate sections 54 are provided wherein each intermediate section 54 is delimited by a stiff support element 27.

Different embodiments of the support elements 17 have in common that they extend only across a limited axial length of the bearing section. The sum of all axial extensions of the support elements of a bearing section 14 covers only a portion of the total length of the bearing section 14.

It may be advantageous to provide almost all of the bearing section 14 with—differently designed—support elements 27, 37. In this context, across the length of the bearing section 14, different support elements 17 can be arranged such that the support action of the bearing section 14 changes in longitudinal direction of the bearing section 14.

While specific embodiments of the invention have been shown and described in detail to illustrate the inventive principles, it will be understood that the invention may be embodied otherwise without departing from such principles.

What is claimed is:

1. A bearing assembly for a drive shaft guided in a protective tube, wherein the drive shaft connects a tool with a drive, wherein the bearing assembly comprises:
bearing tube segments arranged in the protective tube one after another in a longitudinal direction of the protective tube, wherein the bearing tube segments are penetrated by the drive shaft;
wherein a plurality of the bearing tube segments are embodied as a bearing section, respectively, wherein the bearing sections each comprise a central bearing sleeve and support elements projecting away from an outer circumference of the bearing sleeve, wherein the bearing sleeve is radially supported by the support elements on an inner circumference of the protective tube and wherein the bearing sections, each comprised of the bearing sleeve and the support elements, each are embodied as one piece;
wherein the bearing sections are arranged so as to follow each other;
wherein the bearing tube segments each have a length measured in a longitudinal direction of the protective tube and wherein the sum of the lengths of the bearing tube segments is greater than 60% of a length of the protective tube.

2. The bearing assembly according to claim 1, wherein a first one of the bearing sections is supported on a second one of the bearing sections following the first bearing section in the longitudinal direction of the protective tube.

3. The bearing assembly according to claim 2, wherein an end face of the first bearing section is resting on an end face of the second bearing section.

4. The bearing assembly according to claim 2, wherein an end face of the first bearing section comprises first engagement elements extending axially and an end face of the second bearing section that is facing the end face of the first bearing section comprises second engagement elements, wherein the first engagement elements interact with the second engagement elements.

5. The bearing assembly according to claim 1, wherein the bearing sections are secured with anti-rotation action in the protective tube.

6. The bearing assembly according to claim 1, wherein the bearing sections each have a section length of 10 mm to 300 mm.

7. The bearing assembly according to claim 6, wherein the section length is 100 mm to 200 mm.

8. The bearing assembly according to claim 1, wherein the bearing sections each are formed as an injection-molded plastic part.

9. The bearing assembly according to claim 1, wherein the support elements of one of the bearing sections include at least one stiff support element and include elastic support elements.

10. The bearing assembly according to claim 9, wherein the bearing section comprises opposed ends, wherein the elastic support elements include first elastic support elements that are disposed at the opposed ends, and wherein the at least one stiff support element is disposed between the opposed ends.

11. The bearing assembly according to claim 10, wherein the opposed ends support exclusively the first elastic support elements.

12. The bearing assembly according to claim 11, wherein the elastic support elements include at least one second elastic support element, wherein at least two of the stiff support elements are provided and are spaced apart such that an intermediate space is provided between the at least two stiff support elements, wherein the at least one second elastic support element is disposed in the intermediate space.

13. The bearing assembly according to claim 10, wherein the elastic support elements are spring tongues extending in a circumferential direction of the bearing sleeve.

14. The bearing assembly according to claim 10, wherein the bearing sleeve, the at least one stiff support element, and the elastic support elements are embodied as one piece.

15. The bearing assembly according to claim 10, wherein the at least one stiff support element ends at a maximum outer diameter about the bearing sleeve, wherein the maximum outer diameter is smaller or identical to the inner diameter of the protective tube.

16. The bearing assembly according to claim 10, wherein the at least one stiff support element extends in a plane that is oriented perpendicular to a longitudinal center axis of the bearing sleeve.

17. The bearing assembly according to claim 1, wherein the bearing section has a section length and wherein the support elements are arranged across the section length of the bearing section so as to be positioned at an axial spacing relative to each other.

18. The bearing assembly according to claim 1, wherein at least one of the support elements is formed as a support ring.

19. The bearing assembly according to claim 18, wherein the support ring comprises an outer rim and the outer rim comprises a cutout.

20. The bearing assembly according to claim 1, wherein a first one of the bearing sections is inserted into the protective tube from a first axial end of the protective tube and a second one of the bearing sections is inserted into the protective tube from a second axial end of the protective tube.
